(19) United States
(12) Patent Application Publication
(10) Pub. No.: US 2016/0365591 A1
(43) Pub. Date: Dec. 15, 2016

(54) SYSTEM FOR GASIFICATION OF SOLID WASTE AND GENERATION OF ELECTRICAL POWER WITH A FUEL CELL

(71) Applicant: KASHONG LLC, Hollywood, CA (US)

(72) Inventor: Steven G. Goebel, Victor, NY (US)

(21) Appl. No.: 14/830,846

(22) Filed: Aug. 20, 2015

Related U.S. Application Data
(63) Continuation-in-part of application No. 14/739,285, filed on Jun. 15, 2015.

(51) Int. Cl. H01M 8/0612; C10K 1/20; H01M 8/1018; H01M 8/0668; H01M 8/04007; C10J 3/82; C10K 3/04

(52) U.S. Cl. CPC H01M 8/0631; C10J 3/82; C10K 1/20; C10K 3/04; H01M 8/0668; H01M 8/0618; H01M 8/0643; H01M 8/04074; H01M 8/1018; C10J 2300/1238; C10J 2300/0959; C10J 2300/0946; C10J 2300/1646; C10J 2300/1861; H01M 2008/1095; H01M 2250/10

(57) ABSTRACT

A system and method of producing syngas from a solid waste stream is provided. The system includes a low tar gasification generator that gasifies the solid waste stream to produce a first gas stream. A process module cools the first gas stream and removes contaminants, such as metals, sulfur and carbon dioxide from the first gas stream to produce a second gas stream having hydrogen and carbon monoxide. The second gas stream is received by pressure swing absorber which removes carbon monoxide and increases the purity of the hydrogen to allow the generation of electrical power by a PEM fuel cell in a power module. A water gas shift process may be used to convert carbon monoxide recovered from a retentate stream exhausted by the pressure swing absorber.

### BACKGROUND OF THE DISCLOSURE

The subject matter disclosed herein relates to a system for converting solid waste, such as municipal waste and conversion into electrical power using a polymer electrolyte membrane fuel cell.

Traditionally, municipal solid waste (MSW) was disposed of by dumping of the waste into the ocean, burning in incinerators or burying in landfills. Due to undesired environmental effects (e.g. release of methane into the atmosphere and contamination of ground water) of these practices, many jurisdictions have prohibited their expansion or implementation. In some parts of the world, gasification technologies have been used to eliminate municipal waste.

Gasification is a process that decomposes a solid material to generate a synthetic gas, sometimes colloquially referred to as syngas. This syngas typically includes carbon monoxide, hydrogen and carbon dioxide. The produced syngas may be burned to generate steam that drives large gas turbines (50 MW) to generate electricity. Several gasification technologies are used with municipal waste, including an up-draft gasifier, a down-draft gasifier, a fluidized bed reactor, an entrained flow gasifier and a plasma gasifier. All gasifiers utilize controlled amounts of oxygen to decompose the waste. One issue with current systems is that they use gas turbines to produce electrical power. Gas turbines typically require large amounts of waste and correspondingly large amounts of amounts of oxygen and have to be located close to areas where both the waste fuel and oxygen may be readily supplied in large volumes. Further, since steam is generated in the process, to maintain efficiencies the systems should be located in major industrial complexes where the steam can be used in process or district heating systems.

Polymer Electrolyte Membrane Fuel Cells (PEMFC) are electrochemical devices that use hydrogen as a fuel to generate electrical power. PEMFC systems are desirable because of their high conversion efficiency (˜60%) and ability to operate at relatively low temperatures (50-90 C). One challenge with PEMFC systems is the need for high purity hydrogen as a fuel. Due to the hydrogen purity requirements of the PEMFC, the hydrogen is typically acquired via steam reformation of natural gas or by water electrolysis. In the case of natural gas reformation, the gas stream is decomposed into hydrogen and carbon monoxide using a steam reformer having a catalytic heat exchanger. Subsequent processing is used to remove the carbon monoxide which will contaminate the catalyst used in PEMFC systems. A waste gas stream from the reformation process is burned to generate the thermal energy used in the catalytic heat exchanger. Unfortunately this arrangement does not transfer easily to the gasification of MSW as the solid material does not lend itself to integration with the catalytic heat exchanger. Further diluent compounds such as sulfur produced during gasification, will contaminate the heat exchanger catalyst.

Accordingly, while existing gasification to electrical power systems have been suitable for their intended purposes, the need for improvement remains; particularly in providing a system that can operate a PEMFC system using MSW as a an input fuel.

### BRIEF DESCRIPTION OF THE DISCLOSURE

According to one aspect of the invention a system for a system for converting solid waste material to energy is provided. The system includes an input module having a low tar gasification generator configured to produce a first gas stream in response to an input stream of solid waste material, the first gas stream including hydrogen. A process module is fluidly coupled to receive the first gas stream. The process module includes a first heat exchanger operable to cool the first gas stream and at least one clean-up process module fluidly coupled to the first heat exchanger to receive the cooled first gas stream. The at least one clean-up process module is configured to remove at least one contaminant from the first gas stream and produce a second gas stream containing hydrogen and carbon monoxide. The process module further including a pressure swing absorption (PSA) device that receives the second gas stream and produces a retentate stream and a third gas stream comprised of substantially hydrogen. A polymer electrolyte membrane fuel cell is provided and configured to receive the third gas stream and generate electrical power based at least in part from the hydrogen in the third gas stream.

According to another aspect of the invention a method of producing electrical power from a solid waste stream. The method comprising the steps of: receiving the solid waste stream at a gasification generator; receiving an oxygen gas stream at the gasification generator; producing a first gas stream and residual materials using a gasifier; transferring the first gas stream to a first heat exchanger; decreasing the temperature of the first gas stream with the first heat exchanger; performing at least one clean-up process on the first gas stream to remove at least on contaminant; generating a second gas stream with the at least one clean-up process, the second gas stream including hydrogen and carbon monoxide; receiving the second gas stream at a pressure swing absorption (PSA) device; generating a retentate stream from the PSA device; generating a third gas stream from the PSA device; receiving the third gas stream with a polymer electrolyte membrane fuel cell (PEMFC) device; and generating electrical power with the PEMFC device based at least in part on receiving the third gas stream.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of a system for generating electrical power through the gasification of solid waste in accordance with an embodiment of the invention;

FIG. 2 is a schematic diagram of a gasifier module for use with the system of FIG. 1;

FIG. 3 is a schematic diagram of a process module for use with the system of FIG. 1 in accordance with an embodiment of the invention;

FIG. 4 is a schematic diagram of a process module for use with the system of FIG. 1 in accordance with another embodiment of the invention; and

FIG. 5 is a schematic diagram of a power generation module for use with the system of FIG. 1.

The detailed description explains embodiments of the disclosure, together with advantages and features, by way of example with reference to the drawings.

### DETAILED DESCRIPTION OF THE DISCLOSURE

Embodiments of the invention provide advantages in the high efficiency generation of electrical power from solid waste, such as municipal waste. Embodiments of the invention provide advantages in the generation of electrical power with high efficiency using low tar gasification systems that supply hydrogen enhanced syngas suitable for use with a polymer electrolyte membrane fuel cell (PEMFC). Still further embodiments of the invention provide advantages in producing a gas stream from municipal solid waste having lower levels of diluents.

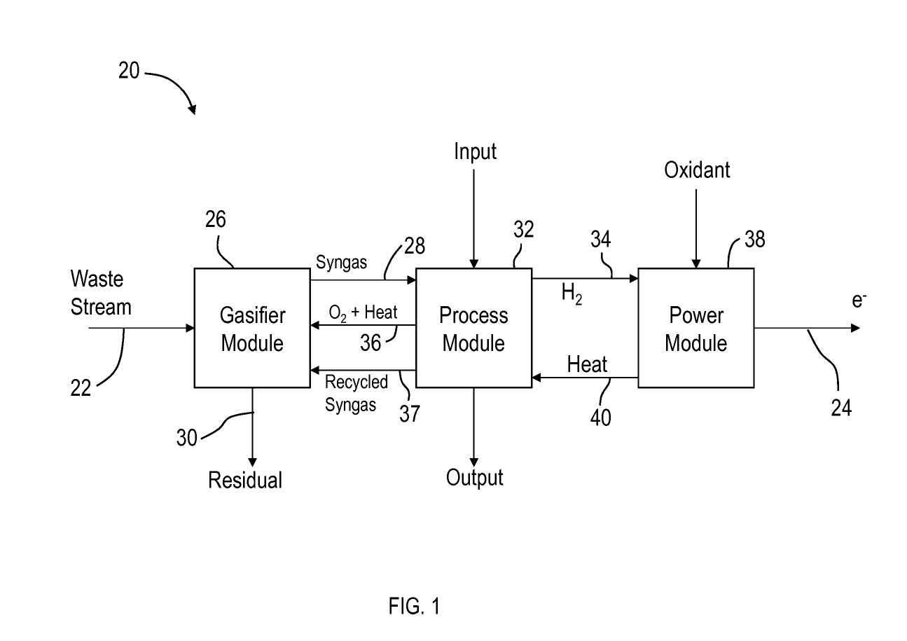

Referring now to FIG. 1, an exemplary system 20 is illustrated for converting a solid waste input stream 22 into generated electrical power 24. The system 20 includes a gasification module 26 that receives the solid waste stream 22 and outputs a syngas 28 and a residual material stream 30. The residual stream 30 may include slag (e.g. a mixture of metal oxides and silicon dioxide) and recovered metals. In one embodiment, the residual stream is recovered and recycled into the manufacture of other products, such as concrete for example. The syngas 28 is mainly comprised of hydrogen (H₂) and carbon monoxide (CO) when oxygen gas is used as an input for the gasification process. Where air is used as an input, the syngas 28 may further include nitrogen or nitrogen compounds. In one embodiment, the gasification module 26 also receives an input of a recycled syngas stream 37. In this embodiment, the recycled syngas stream 37 may offset or replace the use of air as an input. As will be discussed in more detail below, by reducing or eliminating the use of air as an input gas to the gasification process advantages may be gained in reducing the amount of nitrogen compounds in the generated syngas stream 28.

The syngas 28 is transferred from the gasifier module 26 to a process module 32. As will be discussed in more detail herein, the process module 32 modifies the syngas stream 28 to provide an output fuel stream 34 having enhanced hydrogen content with a purity level suitable for use a PEMFC system. To accomplish this, the process module 32 provides several functions, including the quenching of the syngas to reduce or avoid the formation of undesirable compounds (e.g. dioxins and furans), the removal of particulates and solids from the gas stream, and the removal of impurities or diluents such as sulfur, nitrogen, chlorine, carbon monoxide, and carbon dioxide. The process module 32 further conditions the output fuel stream to have the desired pressure, temperature and humidity so that it is suitable for downstream use.

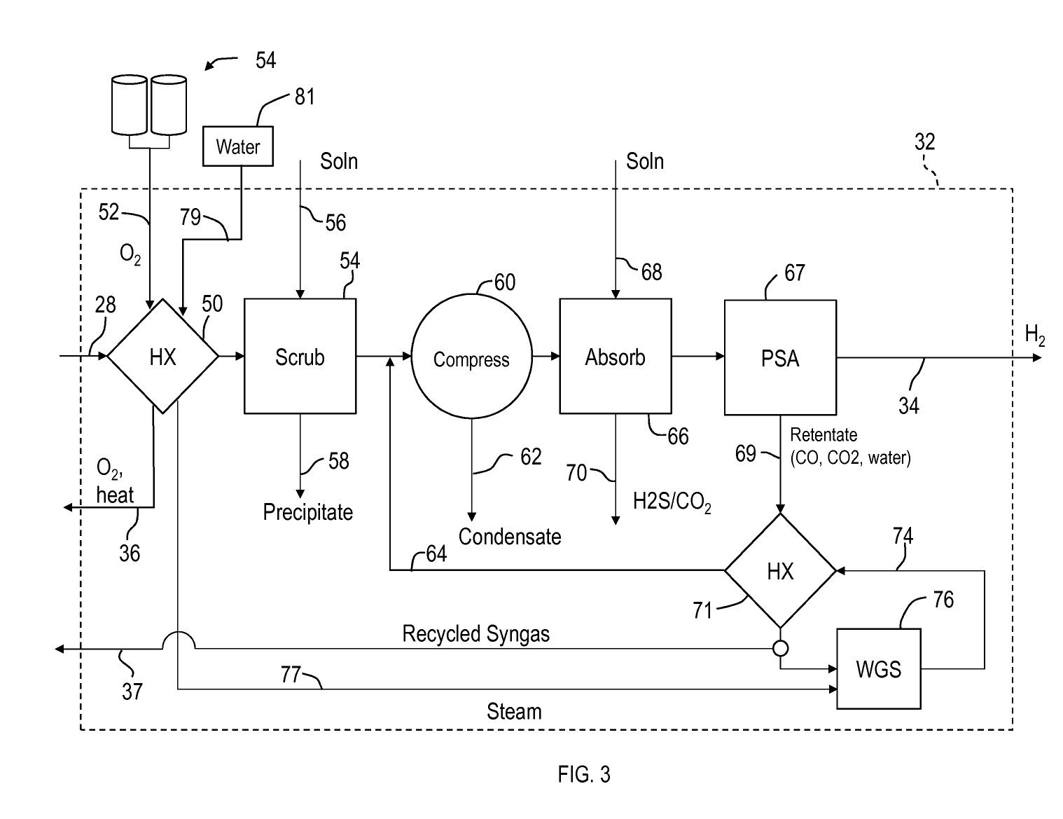

The process module 32 may include a number of inputs, such as but not limited to water, oxygen and solvents such as amine based solvents (e.g. Monoethanolamine). The oxygen input may be used to absorb thermal energy from the syngas 28. Thus, the oxygen stream 36 has an elevated temperature (200 C) when it is transferred to the gasifier module 26. Since the oxygen temperature is increased, the efficiency of the gasification is increased as well. In one embodiment, a steam loop may be used as a heat transfer medium between the syngas and oxygen. Still further advantages may be gained where the thermal energy from the steam loop is used to heat the solid waste stream 22 to reduce the moisture content and improve the quality of the solid waste as a fuel for the gasification process. As will be discussed in more detail herein, the steam loop 77 (FIG. 3) may be used as an input to a water-gas-shift device to convert carbon monoxide into hydrogen and carbon dioxide.

The process module 32 further conditions the output fuel stream 34 to have the desired temperature so that it is suitable for downstream use. In one embodiment, the syngas stream 28 exits the gasifier module at a temperature of 700-1000 C. The absorption of thermal energy from the syngas 28 by the oxygen gas stream allows the process module to condition the syngas stream for use with clean-up processes that operate at lower temperatures. In some embodiments, these clean-up processes operate at temperatures in the range of 50-450 C. However, as is discussed in more detail herein, in an exemplary embodiment, the downstream process is a power module 38 having a PEMFC. Since PEMFC systems operate at reduced temperatures, such as 50-90 C for example, the process module 32 may further condition the temperature of the output fuel stream 34 to the desired temperature.

It should be appreciated that the synergistic use and transfer of thermal energy and heat transfer mediums between the modules 26, 32 provides advantages in increasing the efficiency and improving the performance of the system 20.

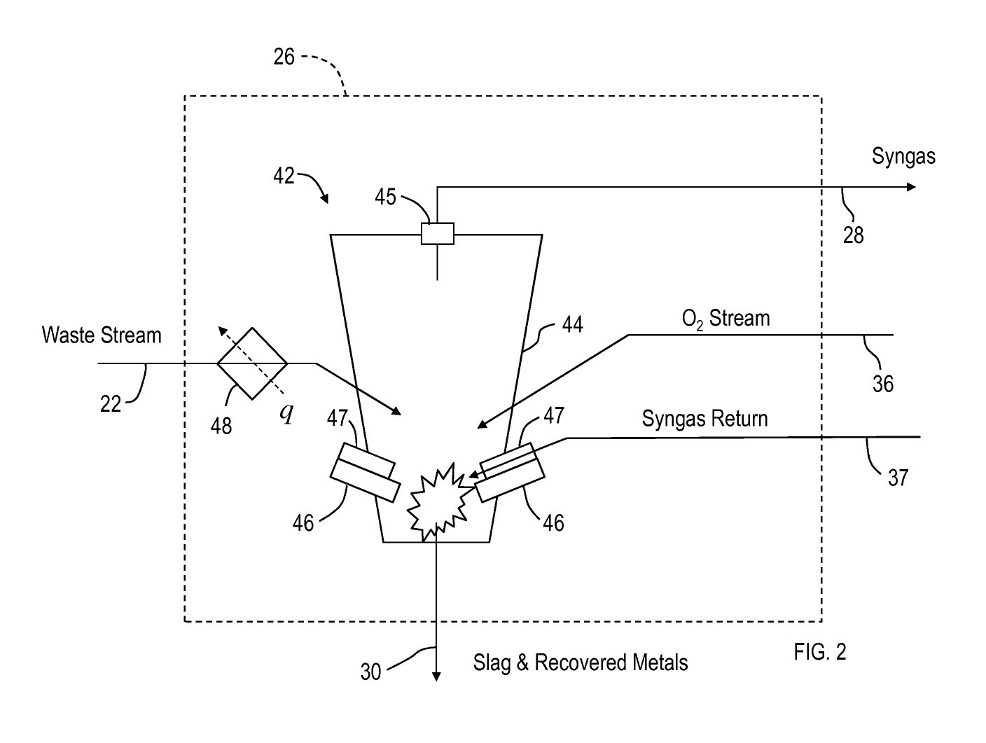

Turning now to FIG. 2, an exemplary gasifier module 26 is shown for converting solid waste 22 into a syngas stream 28. It should be appreciated that the solid waste stream 22 is not limited to municipal waste, but may include other types of solid waste such as but not limited to hazardous waste, electronic waste, bio-waste, coke and tires for example. In one embodiment, the gasifier module 26 includes a plasma gasifier 42 that is configured to receive the waste stream 22, the oxygen stream 36, the recycled syngas 37 and to output the syngas stream 28 and residual stream 30. It should be appreciated that while embodiments herein describe the gasifier module 26 as including a plasma gasifier, this is for exemplary purposes and the claimed invention should not be so limited. In other embodiments, other gasifier technologies that are capable of producing syngas at high temperatures (>1000 C) and with low tar may be used. In one embodiment, the gasifier produces a syngas with a tar level of less than or equal to 0.5 mole % and preferably between 0.1-0.5 mole %.

In one embodiment, the plasma gasifier 42 includes an inverted frusto-conical shaped housing 44. A plurality of plasma torches 46 are arranged near the bottom end of the housing 44. The plasma torches 46 receive a high-voltage current that creates a high temperature arc at a temperature of about 5,000 C. It should be appreciated that while FIG. 2 illustrates a single point of entry for the waste stream 22, the oxygen stream 36, the recycled syngas 37 and a pair of plasma torches, this is for exemplary purposes and the claimed invention should not be so limited. In some embodiments there is a plurality of input ports or suitable manifolds for the streams 22, 36, 37 to allow the streams to be injected about the circumference of the housing 44.

A plasma arc gasifier breaks the solid waste into elements such as hydrogen and simple compounds such as carbon monoxide by heating the solid waste to very high temperatures with the plasma torches 46 in an oxygen deprived environment. The gasified elements and compounds flow up through the housing 44 to an output port 45 that fluidly couples the housing 44 to the process module 32. The syngas stream 28 exits the gasifier module 26 at a temperature of about 1000 C. The residual materials 30, typically inorganic materials such as metals and glasses melt due to the temperature of the plasma and flow out of the housing 44 and are recovered.

In one embodiment, the plasma torches 46 include a shroud 47 that receives the recycled syngas stream 37. The shroud allows the recycled syngas stream 37 to flow over or about the plasma torches 46 prior to entering the gasification chamber. Due to the relatively low temperature of the recycled syngas gas stream 37, heat is transferred from the plasma torches 46 to the recycled syngas stream 37 and overheating of the plasma torches is avoided. It should be appreciated that this also provides advantages in increasing the temperature of the recycled syngas stream 37 closer to the operating temperature of the process within the housing 44 which improves operation and efficiency of the gasification process. It should further be appreciated that using the recycled syngas stream 37 as a shroud cooling flow provides advantages over using air in that fewer or no nitrogen diluents will be formed during the gasification process.

In one embodiment, the gasifier module 26 may include a heat transfer element 48 that transfers a portion of the thermal energy “q” from the heat transfer medium to the waste stream 22 prior to the waste stream 22 entering the plasma gasifier 42. The heat transfer element 48 may be coupled to receive the heat transfer medium from one or more points within the system 20. It should be appreciated that solid waste, such as municipal waste, may have a high moisture content and it may be desirable to lower this moisture content prior to gasification to improve efficiency. Thus the thermal energy q may be used to dry the solid waste stream 22. In one embodiment, the transfer of thermal energy may be selectively applied to the waste stream 22, such as in response to changing conditions in the solid waste for example.

It has further been found that plasma gasifiers provide advantages over other gasifier technologies since they generate very little tar (mixture of hydrocarbons and free carbon) due to the high temperatures used in operation.

Referring now to FIG. 3, an embodiment is shown of the process module 32. The syngas stream 28 is first received by a heat exchanger 50 that reduces the input temperature from about 1000 C to about 150 C. The process module 32 may include an initial quench water spray that reduces the initial input temperature from 1000 C to 850 C. The heat exchanger 50 receives an oxygen gas stream 52 and may also receive water for initial quenching and to be used as a heat transfer medium. In one embodiment the oxygen gas stream 52 is received from a liquid oxygen storage unit 54. The oxygen storage unit 54 may include at least two storage units to allow continuous operation of the system 20 when one of the storage units is empty and being replenished. In one embodiment, the water is received from a water source 81 that may be comprised of one or more water storage units or coupled to a water supply such as a municipal water supply for example.

The oxygen gas stream 52 absorbs thermal energy from the syngas stream 28 as it passes through the heat exchanger 50 to form an oxygen gas stream 36. In one embodiment, the heated oxygen stream 36 has a temperature of 200 C at a pressure of 10 atm (about 147 psi or 1 megapascal). It should be appreciated that heating the oxygen to the boiling phase change point allows for an increase in pressure without the use of a compressor. Providing the oxygen stream 36 with an elevated pressure level provides advantages in increasing the pressure level of the syngas stream 28. As will be discussed in more detail below, a pressurized syngas stream 28 provides further advantages in allowing certain cleaning processes to operate without the use of, or with a reduced amount of, secondary compression. It should be appreciated that mechanical compression of the syngas would be a parasitic load on the system 20 that would reduce the overall efficiency. In the exemplary embodiment, the system is configured to provide the oxygen gas stream 52 at a pressure sufficient to provide a syngas stream 28 at the output of the gasification module 26 at a pressure greater than about 140 psi (0.95 megapascal).

The cooled syngas stream 28 flows from the heat exchanger 50 to a first clean-up process module 54. In one embodiment, the first clean-up process module 54 is a scrubber that receives a solvent (typically water) input 56 and precipitates particulates, such as metals (including heavy metals) and dissolves chemicals, such as halides and alkali, from the syngas stream 28. The first clean-up process module 54 may further remove chlorine from the syngas stream 28. The precipitate stream 58 is captured and removed from the system 20.

In one embodiment, once the particulates and some diluent compounds are removed, the syngas stream 28 flows to an optional compressor 60 that elevates the pressure of the syngas for further processing. In a system with pressurization achieved by boiling of the liquid oxygen supply, the compressor only needs to drive a recirculation flow through the process and power generation modules. The compressor 60 increases the pressure of the syngas stream 28 to 147 psi (1 megapascals). The compressor 60 may include intercoolers that cause water within the syngas stream to condense from the gas. This condensate is captured and removed from the system via a condensate trap 62. It should be appreciated that since the syngas stream 28 enters the process module 32 at an elevated pressure due to the pressurization performed (and the energy used) by the compressor 60 is considerably less than a system where the syngas stream 28 starts at a lower or ambient pressure. It should be appreciated that for a system without a pressurized gas supply, about 22% of the gross electric output would be required to drive a compressor to elevate the syngas pressure from about 14.7 psi to 147 psi (0.101 megapascals to 1 megapascals).

In one embodiment, a retentate gas stream 64 is injected into the syngas stream 28 before compression. As will be discussed in more detail below, this retentate gas stream 64 may be received from a pressure swing absorber (PSA). In other words, the retentate gas stream 64 consists of CO, CO2 and water that was exhausted from the PSA during regeneration. It should be appreciated that advantages are gained by flowing the retentate gas stream 64 prior to compression as the compressor 60 will remove water product from the retentate gas stream and the absorber 66 will remove the CO2 to reduce accumulation of these and other diluents. Further, the energy from the remaining CO may be recovered by a water gas shift (WGS) process.

Once the syngas stream 28 has been compressed, the stream enters a second clean-up process module 66. In one embodiment, the second clean-up process module 66 is an amine based absorber that uses an input solvent 68 such as monoethanolamine (MEA) that absorbs and removes diluents such as carbon dioxide and sulfur (typically as H2S) from the gas stream. These diluents are captured and removed via a diluent stream 70.

After exiting the second clean-up process module 66, the processed syngas stream enters a PSA 67. A PSA is a device used to separate gas components from a mixed gas stream under pressure using an absorbent material. Typically, a PSA will be comprised of a plurality of vessels or “beds” containing a medium that is selected to absorb one or more of the gas components and removing these gas components from the gas stream. The PSA will have multiple vessels, with only some vessels being active for absorbing the gas components at any given time. When the absorbent material in the vessel has reached it absorptive capacity, the PSA switches the gas flow to an unused vessel. A slip stream of the gas is taken from the exit of the vessel currently being used and a small amount of the purified gas is diverted to flow back through the previously used vessel to regenerate the medium. During the regeneration process, the pressure in the vessel being regenerated is lowered allowing the medium to release the previously absorbed gas component and form a retentate gas stream 69.

In the exemplary embodiment, the processed syngas stream from the second clean-up process module 66 is processed by the PSA 67 to pass H₂. As a result, a retentate gas stream 69 is formed from the regeneration of the PSA 67 medium. This retentate gas stream 69 includes CO, CO₂ and water. The retentate gas stream 69 passes through a heat exchanger 71 to increase the temperature of the retentate gas stream to a temperature (e.g. 250-300 C) desirable for operation of a water gas shift process. Upon exiting the heat exchanger 71, a first portion of the retentate gas stream 69 is diverted to form the recycled syngas stream 37 while the remaining or second portion of the retentate gas stream flows to the water-gas-shift (WGS) module 76.

In a WGS reaction the syngas is exposed to a catalyst, such as iron oxide-chromium oxide or a copper-based catalyst for example. The water-gas shift module 76 reduces the carbon monoxide content of the syngas stream to less than or equal to 10 percent by converting it with water vapor to additional hydrogen and carbon dioxide. In one embodiment, the WGS module 76 includes multiple-stages that operate in the 150-450 C temperature range. Each of these stages may be exothermic and additional heat exchangers may be used to remove thermal energy between each stage. It should be appreciated that different catalysts may be used in different stages of the WGS module 76. Steam 77 may be injected into the syngas stream 28 to provide water vapor to enhance the water gas shift reactions occurring within the WGS module 76. In one embodiment, the steam 77 may be generated by flowing a stream of water 79 through the heat exchanger 50. The output gas stream 74 from the WGS module 76 flows through heat exchanger 71 to increase the temperature of retentate stream 69 and is then injected back into the syngas stream prior to the compressor 60.

The output fuel stream 34 exits from PSA 67 as nearly pure H₂ having had the CO and other gas components substantially removed. With the CO gas component substantially removed, the output fuel stream 34 has sufficient purity to operate a PEMFC. In one embodiment, the purity of the H2 at the exit of the PSA 67 is 99.999%. The output fuel stream 34 is then transferred to the power module 38 (FIG. 1). It should be appreciated that the process module 32 may include additional processing modules to condition the output fuel stream 34, such as humidifiers for example.

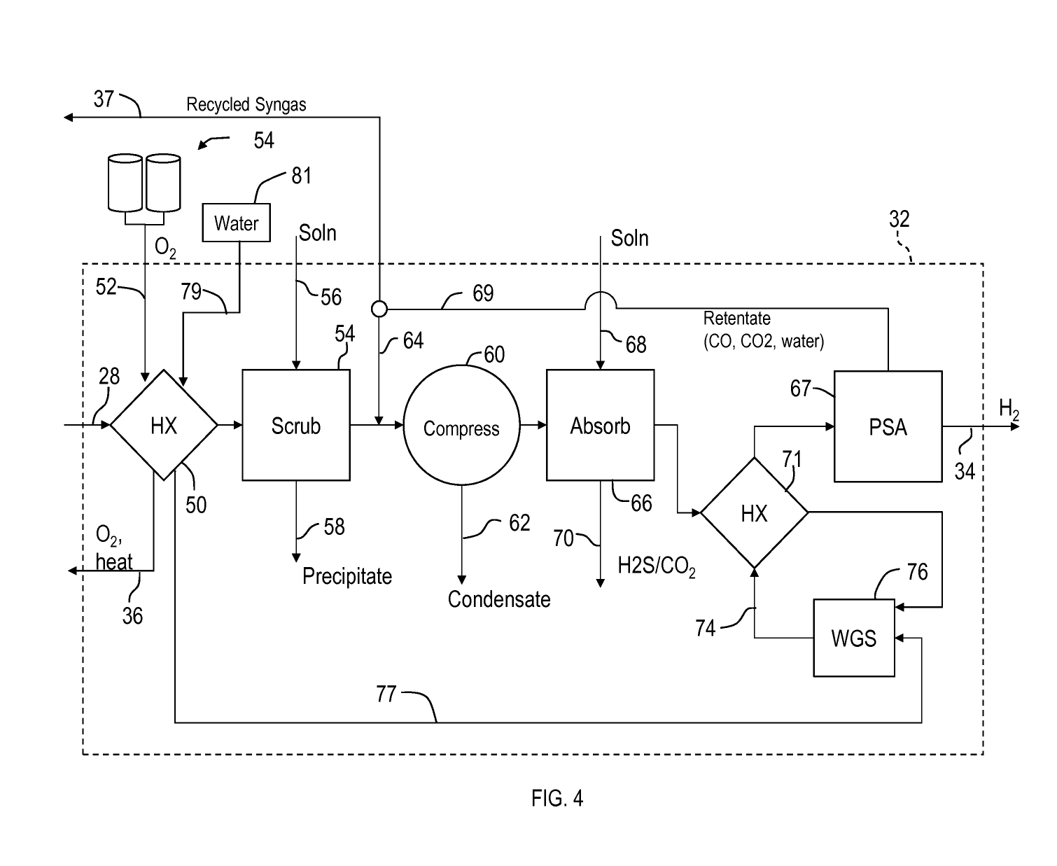

Turning now to FIG. 4, another embodiment is shown of a process module 32. In this embodiment, the syngas stream exiting the absorber 66 is transferred through a heat exchanger 71 prior to being processed by a WGS module 76. In WGS module 76, the carbon monoxide content of the syngas stream is reduced. The syngas stream 74 exiting the WGS module 76 passes through heat exchanger 71 to increase the temperature of the syngas stream exiting the absorber 66. The syngas stream 74 then passes to the PSA module 67 wherein the CO and other gas components are substantially removed to generate the output fuel stream 34. In this embodiment, the retentate stream 69 exits the PSA module 67 and is bifurcated into a first portion 37 and second portion 64. The recycled syngas stream 37 is transferred back to the gasifier module 26 as discussed above. The retentate stream second portion 64 is injected into the syngas stream prior to the compressor 60.

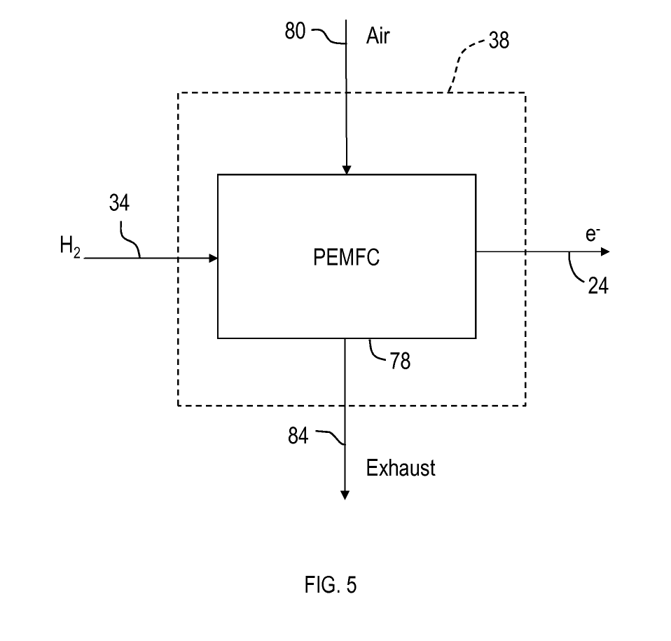

Referring now to FIG. 5, an exemplary power module 38 is shown having a PEMFC system 78. A PEMFC system 78 typically includes a plurality of individual cells arranged in a stack. Each cell includes an anode and a cathode separated by a proton exchange membrane. The cathode-membrane-anode arrangement is sometimes referred to as a membrane-electrode-assembly or “MEA.” Hydrogen gas 34 is introduced to the anode side of the cell and an oxidant, such as air 80, is introduced to the cathode side of the cell. The hydrogen and oxidant working fluids are directed to the cells via input and output conduits or ports formed within the stack structure.

The hydrogen gas electrochemically reacts at the anode electrode to produce protons and electrons, wherein the electrons flow from the anode through an electrically connected external load, and the protons migrate through the polymer membrane to the cathode. At the cathode, the protons and electrons react with oxygen to form water, which additionally includes any feed water that is dragged or carried through the membrane to the cathode. The electrical potential across the anode and the cathode can be exploited to provide power 24 to an external load.

More specifically, the output gas stream 34 enters the power module 38 and is received by the PEMFC system 78. To produce electrical power 24, the PEMFC system 78 receives an oxidant, such as air for example, as an input 80. The air passes through the cathode side of the cells in the PEMFC system 78 and cooperates with the hydrogen in output gas stream 34 to produce electrical power 24. The exhaust stream 84 (air and water) then exits the system.

It should be appreciated that embodiments of the invention provide advantages in allowing the gasification of solid waste to produce electrical power using a PEMFC system. Further embodiments provide for recycling a portion of the processed syngas to the gasifier. This recycled syngas stream may be used to cool plasma torches in the gasifier in place of air and reduce the introduction of nitrogen diluents into the generated syngas stream. Still further embodiments provide advantages in reducing the CO content of the syngas stream to produce a purified hydrogen fuel that is suitable for use with a PEMFC system.

The term “about” is intended to include the degree of error associated with measurement of the particular quantity based upon the equipment available at the time of filing the application. For example, “about” can include a range of ±5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A system for converting solid waste material to energy comprising:
an input module having a low tar gasification generator configured to produce a first gas stream in response to an input stream of solid waste material, the first gas stream including hydrogen;
a process module fluidly coupled to receive the first gas stream, the process module including a first heat exchanger operable to cool the first gas stream, the process module further including at least one clean-up process module fluidly coupled to the first heat exchanger to receive the cooled first gas stream, the at least one clean-up process module configured to remove at least one contaminant from the first gas stream and produce a second gas stream containing hydrogen and carbon monoxide, the process module further including a pressure swing absorption (PSA) device that receives the second gas stream and produces a retentate stream and a third gas stream comprised of substantially hydrogen; and
a polymer electrolyte membrane fuel cell configured to receive the third gas stream and generate electrical power based, at least in part, from the hydrogen in the third gas stream.

2. The system of claim 1, wherein the process module further includes a water-gas-shift device arranged to receive one of the second gas stream or the retentate stream and is configured to convert carbon monoxide and water vapor to generate a fourth gas stream including hydrogen and carbon dioxide, the fourth gas stream having a lower amount of carbon monoxide than the one of the second gas stream or the retentate stream.

3. The system of claim 2, wherein the process module further includes a second heat exchanger fluidly coupled between the PSA device and the water-gas-shift device to receive the retentate stream, the second heat exchanger being configured to transfer thermal energy to the retentate stream.

4. The system of claim 3, wherein the second heat exchanger is fluidly coupled to receive the fourth gas stream and inject the fourth gas stream into the second gas stream.

5. The system of claim 4, wherein the gasification generator is fluidly coupled to receive a portion of the retentate stream upstream from the water-gas-shift device.

6. The system of claim 5, wherein:
the gasification generator includes at least one plasma torch; and
the gasification generator is configured during operation to cool the at least one plasma torch with the portion of the retentate stream received by the gasification generator.

7. The system of claim 5, wherein the first heat exchanger is fluidly coupled between a water source and the water-gas-shift device, the first heat exchanger being configured in operation to generate steam and transfer the steam to the water-gas-shift device.

8. The system of claim 4, wherein:
the at least one clean-up process module includes a first clean-up process module and a second clean-up process module, the first clean-up process module being fluidly coupled to receive the first gas stream from the first heat exchanger, the second clean-up process module being fluidly coupled to receive the first gas stream from the first clean-up process module and produce the second gas stream; and
the second heat exchanger is fluidly coupled to inject the fourth gas stream between the first clean-up process module and the second clean-up process module.

9. The system of claim 2, further comprising:
a second heat exchanger fluidly coupled between the at least one clean-up process module and the PSA device; and
wherein the water-gas-shift device is fluidly coupled to receive the second gas stream from the second heat exchanger and flow the fourth gas stream to the PSA device.

10. The system of claim 9, wherein:
the fourth gas stream flows through the second heat exchanger prior to the PSA device; and
the second heat exchanger is configured to transfer thermal energy from the fourth gas stream to the second gas stream.

11. The system of claim 10, wherein the PSA device is fluidly coupled to transfer the retentate stream to the at least one clean-up process module.

12. The system of claim 11, wherein PSA device is fluidly coupled to the gasification generator to receive a portion of the retentate stream.

13. The system of claim 12 wherein:
the at least one clean-up process module includes a first clean-up process module and a second clean-up process module, the first clean-up process module being fluidly coupled to receive the first gas stream from the first heat exchanger, the second clean-up process module being fluidly coupled to receive the first gas stream from the first clean-up process module and produce the second gas stream; and
the PSA device is fluidly coupled to inject the retentate stream between the first clean-up process module and the second clean-up process module.

14. The system of claim 12 wherein:
the gasification generator includes at least one plasma torch; and
the gasification generator is configured during operation to cool the at least one plasma torch with the portion of the retentate stream received by the gasification generator.

15. A method of producing electrical power from a solid waste stream comprising:
receiving the solid waste stream at a gasification generator;
receiving an oxygen gas stream at the gasification generator;
producing a first gas stream and residual material stream using a gasifier;
transferring the first gas stream to a first heat exchanger;
decreasing a temperature of the first gas stream with the first heat exchanger;
performing at least one clean-up process on the first gas stream to remove at least on contaminant;
generating a second gas stream with the at least one clean-up process, the second gas stream including hydrogen and carbon monoxide;
receiving the second gas stream at a pressure swing absorption (PSA) device;
generating a retentate stream from the PSA device;
generating a third gas stream from the PSA device;
receiving the third gas stream with a polymer electrolyte membrane fuel cell (PEMFC) device; and
generating electrical power with the PEMFC device based at least in part on receiving the third gas stream.

16. The method of claim 15, wherein at least one clean-up process comprises:
a first clean-up process that precipitates particulates and dissolve chemicals from the first gas stream; and
a second clean-up process that removes sulfur and carbon dioxide from the first gas stream.

17. The method of claim 16, further comprising:
increasing a temperature of the retentate stream in a second heat exchanger;
receiving the retentate stream from the second heat exchanger in a water-gas-shift device; and
generating a fourth gas stream from the water-gas-shift device.

18. The method of claim 17, further comprising flowing the fourth gas stream through the second heat exchanger, and wherein the step of increasing the temperature of the retentate stream includes increasing the temperature of the retentate stream using thermal energy from the fourth gas stream.

19. The method of claim 18, further comprising injecting the fourth gas stream into the first gas stream prior to the second clean-up process.

20. The method of claim 17, further comprising bifurcating the retentate stream between the second heat exchanger and the water-gas-shift device into a first retentate portion and a second retentate portion, the second retentate portion being received by the water-gas-shift device.

21. The method of claim 20, further comprising flowing the first retentate portion to the gasification generator.

22. The method of claim 21, further comprising cooling at least one plasma torch in the gasification generator with the first retentate portion.

23. The method of claim 17, further comprising:
generating steam with the first heat exchanger; and
receiving the steam at the water-gas-shift device.

24. The method of claim 16, further comprising:
increasing a temperature of the second gas stream prior to the PSA device with a second heat exchanger;
receiving at a water-gas-shift device the second gas stream from the second heat exchanger;
generating a fourth gas stream with the water-gas-shift device; and
receiving the fourth gas stream at the PSA device.

25. The method of claim 24, further comprising injecting the retentate stream into the first gas stream prior to the second clean-up process.

26. The method of claim 25, further comprising bifurcating the retentate stream prior to injecting the retentate stream into the second gas stream into a first retentate portion and a second retentate portion, the second retentate portion being injected into the second gas stream.

27. The method of claim 26, further comprising flowing the first retentate portion to the gasification generator.

28. The method of claim 27, further comprising cooling at least one plasma torch in the gasification generator with the first retentate portion.
